(19) United States
(12) Patent Application Publication
(10) Pub. No.: US 2003/0000391 A1
(43) Pub. Date: Jan. 2, 2003

(54) Organic nutritional formula

(76) Inventors: Jay Highman, Westerville, OH (US); Jeffrey Wayne Liebrecht, Columbus, OH (US)

Correspondence Address: Donald O. Nickey, 8765 Colvin Drive, Plain City, OH, 43164, US

(21) Appl. No.: 09/878,737

(22) Filed: Jun. 12, 2001

(51) Int. Cl. A23L 1/30; A23L 1/00

(52) U.S. Cl. 99/275

(57) ABSTRACT

This invention relates to a nutritional beverage substantially free of chemical pesticides, antibiotics, added hormones, herbicides, genetically modified plants and chemical solvents that utilizes organic soy protein and organic brown rice syrup as major components. The soy protein is treated with an enzyme to dramatically reduce the non-digestible soy carbohydrates. The beverage preferably also contains water soluble vitamins, oil soluble vitamins, and flavors. The use of brown rice syrup, soy proteins and a special enzyme treatment in a preferred embodiment of the beverage provides a beverage with a smooth texture, a pleasant taste and a light, refreshing mouthfeel. The beverage also has excellent physical stability over shelf life.

### TECHNICAL FIELD

This invention relates to an improved nutritional formula, which is “organic” and possesses highly acceptable taste, mouth feel and an improved reconstituted stability. The nutritional formula uses organic brown rice syrup as the major source of carbohydrate, and organically grown non-solvent extracted edible oils as the source of lipids. As the source of protein the formula uses an organically grown and processed non-dairy, lactose free soymilk protein that is not derived from genetically modified organisms (GMO) bean like soy protein concentrates and isolates. The soymilk protein is subjected to an enzyme treatment to reduce the non-digestible carbohydrates that can cause discomfort and fussiness in infants, toddlers and children. All of the soybean oil required for a nutritionally balanced oil blend comes in with the soymilk protein, which contributes natural antioxidant properties not found in conventional formulas.

### BACKGROUND OF THE INVENTION

A growing number of individuals are turning to “organic” foods as their preferred source of nutrition. Organic foods are not genetically modified and are grown and prepared without the use of chemical pesticides, growth hormones, antibiotics, herbicides or synthetic fertilizers and are processed without the use of solvents such as hexane. Further, organic ingredient processing is like kosher processing in that separate production lines are used for organic and non-organic ingredients or special cleaning procedures are used between non-organic and organic runs.

A number of certification boards and some states, such as California, have procedures and regulations that must be followed for a food ingredient or food product to be labeled as organic. One such board is the National Organic Standards Board (NOSB). The NOSB prohibits organic growers from using chemical pesticides, herbicides or fertilizers on their land for at least three years. NOSB standards currently allow up to 5 percent of the ingredients in nutritional products labeled “organic” to be non-organic, provided those ingredients are not widely available in organic form or on the USDA list of unacceptable ingredients. The growing popularity of organic foods has reached a national level as well. The United Stated Department of Agriculture's final national organic rule which became effective Apr. 21, 2001. There must be compliance with this law by Oct. 21, 2002.

The consuming public is aware that organic foods reduce the health risks associated with consuming foods that are tainted with chemical solvents, pesticides, herbicides, and the like. While adults can carefully choose their source of nutrition, infants, toddlers and children are forced to consume liquid formulas that are not organic. One aspect of the present invention is directed to an infant formula and a nutritional beverage for toddlers and children that are organic. The invention is also directed to a “non-dairy” formulation based on organic soymilk as the sole source of protein. The invention is also directed to a method to prepare such nutritional beverages.

Conventional infant formulas are derived, to a large extent, from cow's milk. After being diluted, the cow's milk is enriched with whey proteins, diverse carbohydrates such as lactose, dextrin, sucrose, maltose and starches, different mixtures of vegetable and animal fats, vitamins and minerals. These components are present in suitable amounts to meet the requirements of low birth weight newborns or healthy term infants as a sole source of nutrition during the first and second semesters of life. Sometimes, infant formulas also contain isolated milk proteins, isolated vegetable proteins or protein hydrolysates, from diverse sources such as casein and lactalbumin. Also, these infant formulas have one or more carbohydrates (sucrose, dextrin, maltose and starch), mixtures of diverse kinds of fats, minerals and vitamins, to meet not only the healthy newborns' nutritional requirements, but also of infants and children with clinical symptoms of lactose intolerance, protein intolerance and, in general, with diverse malabsorption-malnutrition syndromes.

Conventional soy-based infant formulas are derived from non-organic, GMO soy protein concentrates or isolates based on separation techniques that utilize caustic solubilzations, acid precipitations and numerous wash cycles. An additional benefit of the inventive organic formulation is that it is completely free of dairy proteins and carbohydrate (lactose) and based on organic soy protein. Many consumers have elected to choose non-dairy foods, including soy based products, due to vegetarian beliefs or intolerances to dairy proteins and lactose.

The European Society of Pediatric Gastroenterology and Nutrition (ESPGAN), the American Academy of Pediatric (AAP), the Codex Alimentarius Mundi, and the European Community Council, among other organizations, have set forth general guidelines for the composition of infant formulas.

As used herein, the term “infant formula” is intended to refer to the well established understanding as defined in the United States Infant Formula Act, (106 and 107 C.F.R.). The term “organic” is intended to refer to a food that complies with the Federal Organic Foods Production Act (1990) or the California Organic Foods Act of 1990 or those certified by the National Organic Standards Board or the final USDA organic rules.

Nutritional products, other than infant formulas, such as those currently used in hospitals, are based on the utilization of diverse protein sources (casein, sodium and calcium caseinate, isolated soy protein, protein hydrolysates and/or crystalline amino acids), mixtures of vegetable and animal fats, carbohydrates (basically glucose polymers), vitamins and minerals to meet, at least, the dietary intakes recommended for healthy individuals (Committee on Dietary Allowances, Food and Nutrition Board, Nat Acad Sci, 9th Ed, 1980).

Protein energy malnutrition (PEM) is found in many patients admitted to hospitals. This happens not only in developing countries, but also in those with a high socioeconomic level. Proper nutritional support for such patients, while not a primary mode of treatment is, nevertheless, an important factor for therapy and recovery. It is, therefore important to administer a nutritionally balanced organic diet free of contaminates such as pesticides and herbicides, adequate to the needs of the patient. This is especially true for those patients where conventional feeding is contra-indicated (gastroenterological patients) or is insufficient (hypercatabolic patients). Further, these patients are at greater risk for developing complications that are associated with foods contaminated with pesticides, herbicides and chemical solvents.

### BACKGROUND ART

Numerous soy protein based nutritional formulas have been developed and patented over the years. Representative formulas are disclosed in the following U.S. Pat. Nos. 6,146,670 to Prieto et al.; Suh et al.; 5,686,491 to Sherwood; and 5,565,225 to Johnston. The teachings of these patents, as they evidence the state of the art, are herein incorporated by reference.

While much work has been done to prepare various soy based nutritional formulas, there has been no effort put forth to develop an organic nutritional formula that is made with organic soy proteins with enzyme treatments. Stachyose and raffinose are nondigestable soy polysaccharides that can cause gassiness, bloating and discomfort in infants. Use of a alpha-galactosidase enzyme (Validase AGS from Valley Research, Inc., South Bend, Ind.) to treat the protein slurry for 120 minutes at 120-130 F. with the enzyme at 0.25% by weight of the soymilk powder can reduce the levels of these two polysaccharides to less than 0.2% of the total carbohydrate profile.

It is thus apparent that a need exists for a pleasant tasting organic soy based nutritional formula that will provide significant levels of nutrition.

### DISCLOSURE OF THE INVENTION

There is disclosed a nutritional formula, said formula comprising: 1) organic protein, said protein being of a concentration of between 14 and 30 grams per liter of formula; 2) organic lipid, said lipid being of a concentration of between 20 and 46 grams per liter of formula; 3) organic carbohydrates, said carbohydrates being of a concentration of between 50 and 110 grams per liter of formula; 4) vitamins; and 5) minerals. As used herein and in the claims the values reported per liter of formula are for a ready to feed (RTF) liquid nutritional.

The protein has as its source organic soy protein; said lipid has as its source organic soy, organic coconut, organic high oleic sunflower oil or another organic vegetable oil or a blend thereof; and said carbohydrates have as their source organic brown rice syrup, corn syrup, glucose polymers, other carbohydrates or blends thereof. Preferably, the source of carbohydrate is brown rice syrup.

Preferably, the protein is of a concentration between 19 and 25 grams per liter of formula, said lipid is of a concentration of between 26 and 43 grams per liter of formula, and said carbohydrates are of a concentration of between 65 and 95 grams per liter of formula. More preferably, said protein is of a concentration of between 20 and 24 grams per liter of formula, said lipid is of a concentration of between 26 and 40 grams per liter of formula, and said carbohydrate, preferably organic brown rice syrup, is at a concentration of between 70 and 90 grams per liter of formula.

In a preferred embodiment of the invention, said protein is of a concentration of approximately 22 grams per liter of formula and has as its source organic soymilk; said lipid is of a concentration of approximately 33 grams per liter of formula and has as its source a blend of soy lecithin, soy oil, organic coconut oils, and organic high oleic sunflower oil; and said carbohydrate is of a concentration of approximately 81 grams per liter of formula. The preferred source of carbohydrate is organic brown rice syrup. In this formula, the lipid provides up to 45% of the calories and the carbohydrates provide up to 50% of the calories in the formula.

The formula has as its preferred protein source organic soymilk or soybeans; said lipid has as its source organic soy oil, organic coconut oil, a organic high oleic sunflower oil and soy lecithin; and said carbohydrate is preferably organic brown rice syrup.

There is further disclosed an organic nutritional beverage comprising:

a) soymilk or soybeans;

b) tricalcium phosphate;

c) brown rice syrup;

d) high oleic sunflower oil;

e) coconut oil;

f) soybean oil;

g) soy lecithin;

h) flavors;

i) enzymes;

j) oil soluble vitamins;

k) water soluble vitamins;

l ) taurine;

m) L-camitine; and

n) L-methionine.

There is further disclosed an organic nutritional beverage additionally containing at least one of eicosapentaenoic acid (EPA) and docasahexaenoic acid (DHA).

There is also disclosed a ready-to-feed nutritional beverage comprising:

a) water;

b) from about 8 to about 12 gms of an organic brown rice syrup per 100 kcal of beverage; and

c) from about 0.05 to about 0.5 gms per 100 kcal of a source of calcium selected from tricalcium phosphate, calcium citrate, calcium carbonate, calcium lactate gluconate and mixtures thereof.

In a more preferred embodiment the beverage uses tricalcium phosphate as the source of calcium and contains soy lecithin. The beverage may also contain oil soluble vitamins and/or water soluble vitamins. The pH of the RTF beverage is preferably in the range of 6.5 to about 7.0.

### SUMMARY OF THE INVENTION

The present invention is directed to an organic nutritional beverage wherein the beverage may be in the ready-to-drink form (single strength), a concentrated liquid or a powder. The beverage according to the invention preferably contains water soluble vitamins such as pantothenic acid, biotin, vitamin B₁₂, folic acid, vitamin B₆, niacin, vitamin B₂, vitamin B, as well as bioavailable iron, selenium, L-methionine, L-carnitine, taurine, and oil soluble vitamins. The pH of the nutritional beverage in the range of from about 6.0 to about 7.5, with a pH of 6.25 to 7.25 being more preferred and a pH of 6.65 to 6.85 being most preferred.

As used herein, the term “beverage” refers to a liquid composition, which is in a single-strength, ready-to-serve, drinkable form (RTF). Beverages of the present invention typically comprise at least 70% by weight, preferably at least 80% by weight, water. Beverages contemplated within the scope of this invention may also be obtained by adding water to concentrates and powders.

As used herein, the term “comprising” or “comprises” means various components can be co-jointly employed in the beverages and concentrates of the present invention. Accordingly, the more restrictive terms “consisting essentially of”

The soy protein useful in this invention can be supplied by a limited number of commercial sources, which do not use pesticides, herbicides and inorganic fertilizers to grow the soybeans. Soymilk powder contains approximately 44% protein by weight and high levels of naturally occurring soybean oil. Commercially available sources of soymilk powder that are useful in the present invention are soymilk powder from Devansoy Farms, Carroll Iowa; and soymilk flour from SunRich Natural, Hope Minn. Preferably, the inventive beverage has soy milk powder present in the range from about 6 to about 10 gms per 100 kcal of RTF formula.

The carbohydrate may be any carbohydrate source appropriate for use in organic beverages. However, one preferred source of organic carbohydrate is brown rice syrup. It has been found that the use of brown rice syrup is highly effective in masking the offensive flavors from the vitamins and minerals added to the beverage. Further, brown rice syrup provides a nutritional benefit compared to the empty calories associated with refined sources of carbohydrate such as sucrose and corn syrup solids. Refined sugars upon consumption go directly into the blood stream where they spike insulin levels, promote excess fat storage, elevate triglycerides, affect brain chemistry and impair absorption of trace minerals. It is preferred that the organic nutritional beverage comprise about 7-13 grams of brown rice syrup per 100 kcal of formula and most preferably from about 9-11 grams per 100 kcal of RTF formula.

The lipid content of the inventive beverage is from about 3-7 grams per 100 kcal of beverage. The major portion of the lipid is preferably provided from organically prepared soy bean oil naturally occurring in the soymilk powder, other organic sources of lipids include high oleic sunflower oil and coconut oil. Certified organic oils are prepared from non-genetically modified seeds. These oils are expeller pressed and not hexane extracted. The use of hexane to prepare edible oils is known to leave traces of residual hexane, which is unacceptable in the beverage according to this invention. Those skilled in the art will appreciate that other organic lipids can be used in the inventive beverage. Representative of another source of lipid or fatty acids that can be used in the beverage include fish or vegetable oils, which have high levels of certain polyunsaturated fatty acids. Fish oils and some grains are rich in fatty acids such as eicosapentaenoic acid (EPA) and docosahexaenoic acid (DHA). These fatty acids are characterized by having a double bond in the w-3-position. Arachidonic and linolenic acids are also useful fatty acids in the beverage according to the invention.

An additional aspect of the invention relates to simultaneously achieving an organic nutritional beverage that uses brown rice syrup as a novel source of carbohydrate and which contains a nutritionally significant level of vitamins. Those skilled in the nutritional arts will readily appreciate what vitamins can be used to accomplish the vitamin fortification. Representative of the vitamins useful in the present invention are niacinamide, D-calcium pantothenate, pyridoxine hydrochloride, riboflavin, thiamin mononitrate, cyanocobalamin, folic acid, biotin as well as sodium selenite, taurine, L-camitine, L-methionine. The beverage of the present invention may also be supplemented with the oil soluble vitamins A, D, E and K.

One important embodiment of the present inventive beverage is that it contains at least 15%, more preferably at least 20%, of the United Stated Recommended Daily Intake (USRDI), as established by the U.S. Food & Drug Administration, for calcium and iron in a 240 ml serving. In one embodiment of the invention the beverage provides at least 25% of the USRDI for calcium and at least 15% of the USRDI for iron in a 240 ml serving. There are well-recognized problems associated with adding such high levels of iron and calcium to foods and beverages. Iron supplements tend to discolor foodstuffs and be organoleptically unacceptable. Moreover, it is particularly difficult to formulate foods, and especially beverages, containing mixtures of calcium supplements and iron supplements, inasmuch as these minerals tend to interact. This interaction not only affects the organoleptic and aesthetic properties of the foods and beverages, but also undesirable affects the nutritional bioavailability of these minerals themselves. The present invention, in part, is based upon the use of brown rice syrup as the source of carbohydrate. This allows for a beverage with high levels of calcium and iron without significant detrimental impact on taste, mouthfeel and physical stability. Preferably, the iron is in the ferrous (iron II) state, however, ferric iron (iron III) is also acceptable. The ferrous iron is better tolerated and more efficiently utilized by the body than the ferric iron. The preferred form of iron is ferrous sulfate.

An additional aspect of the present invention relates to the beverage's pleasant taste and light mouthfeel. It has been determined that the use of brown rice syrup achieves the goals of pleasant taste and good mouthfeel without the strong, bitter, astringent soy notes typically found in soy protein concentrate and isolate formulations.

It has also been determined that to achieve the beverage's pleasant taste and mouthfeel that the use of soy lecithin is preferred as a source of lipid and an emulsifier/stabilizer. The amount of soy lecithin can range from 0.01 to 0.1 grains per 100 kcal of beverage. This approach is contrary to conventional wisdom, which suggests that when high levels of calcium are added to a beverage, a conventional stabilizer should also be used. The prior art teaches that pectins, algins, hydrolyzed starches, xanthan gum and other edible gums should be added. The use of these materials is contrary to the present invention as these gums cannot be organically produced. Thus, one aspect of the present invention resides in the use of an organic brown rice syrup in combination with soy lecithin to produce a beverage with high levels of calcium, a pleasant, clean tasting character, and a smooth, creamy texture with no evidence of destabilized proteins.

Further, in yet a more preferred embodiment, the beverage according to the invention uses expeller pressed oils for the source of lipid. These oils are especially preferred as they have no residual extraction solvent present.

In one embodiment the beverage according to this invention can be prepared with the following ranges of properties and components:

RANGE PER 100 ML
SERVING AS FED

| ITEM | GENERAL | PREFERRED |
|---|---|---|
| Energy (kcal) | 50-90 | 60-80 |
| Protein (gm) | 1.5-4.5 | 1.5-3 |
| Carbohydrate (gm) | 5-10 | 7-11 |
| Fat (gm) | 2-5 | 3-4 |
| Calcium (mg) | 70-150 | 85-105 |
| Iron (mg) | 0.5-2 | 1-2 |
| Vitamin C (mg) | 10-20 | 12-16 |
| Vitamin B₁ (mcg) | 50-90 | 60-80 |
| Vitamin B₂ (mcg) | 50-90 | 60-80 |
| Niacin (mcg) | 700-900 | 725-825 |
| Vitamin B₆ (mcg) | 35-55 | 38-47 |
| Folic Acid (mcg) | 5-15 | 8-12 |
| Vitamin B₁₂ (mcg) | 0.1-0.4 | 0.18-0.30 |
| Biotin (mcg) | 1-4 | 1.5-3 |
| Pantothenic Acid (mcg) | 250-400 | 290-350 |
| Vitamin A (IU) | 180-240 | 200-220 |
| Vitamin D (IU) | 30-60 | 35-55 |
| Vitamin E (IU) | 0.5-2.5 | 1.0-2.0 |
| Vitamin K (mcg) | 4.0-8.0 | 5.0-7.0 |

The beverage according to the invention would be especially beneficial for toddlers/children of 1-10 years of age. Various modifications of components, such as the number and type of lipids, can be made without departing from the fundamental discovery that use of organic brown rice syrup and a source of calcium selected from tricalcium phosphate, calcium citrate, calcium carbonate, calcium lactate gluconate and mixtures thereof, can produce a physically stable and good tasting nutritional beverage. In a further aspect of the invention, it has been discovered that the use of brown rice syrup as the predominate source of carbohydrate improves the flavor of the beverage by effectively masking the objectionable flavors of the vitamins and minerals. Further, even though the rice syrup has a D. E. of about 42, the sweetness is acceptable and compatible to soymilk without being over powering. Additionally, it is believed that the beverage according to the invention is the first nutritional beverage to use organic expeller pressed oils as the source of lipid, thereby avoiding the presence of trace amounts of solvents, such as hexane.

### DETAILED DESCRIPTION OF THE PREFERRED EMBODIMENTS

In accordance with the foregoing summary of the invention, the following Example I is one embodiment of the beverage of the present invention and a method of its production. In Example I the following bill of materials was utilized.

Bill of Materials

| | Kg per 1000 kg Pwd | |
|---|---|---|
| Ingredient | Batch | Gms per 100 kcal |
| Soymilk Powder* | 314.2 | 6.38 |
| Tricalcium Phosphate | 15.3 | .310 |
| Validase AGS Enzyme | .786 | .016 |
| Brown Rice Syrup* | 624 | 12.679 |
| HO Sunflower Oil* | 93.4 | 1.89 |
| Coconut Oil* | 47.6 | .966 |
| L-Methionine | 1.23 | .025 |
| Soy Lecithin | 3.1 | .063 |
| Vanilla Flavor | 3.0 | .061 |
| Oil Soluble Vitamin Premix | 2.5 | 0.050 |
| Water Soluble Vitamin | 8.4 | .170 |
| Premix | | |
| TOTAL | 1114.0 | 22.63 |

*materials were certified organic

To convert from gms per 100 kcal to 100 ml of RTF beverage one multiplies the gms per 100 kcal by 0.7 to arrive at per 100 ml of RTF. To convert from gms per 100 kcal to 100 gms of powder one uses approximately 4.9 as the factor. The organic soymilk powder was obtained from Devansoy Farms, Carroll, Iowa; the organic HO (high oleic) sunflower and organic coconut oils and non-GMO soy lecithin were obtained from Spectrum Commodities of Petaluma, Calif.; the organic brown rice syrup was obtained from California Natural Products of Lathrop, Calif.; the organic vanilla flavor was obtained from Givaudan of Cincinnati, Ohio; the tricalcium phosphate was obtained from Ohio Chemical Services, Inc., Columbus, Ohio; the enzyme was obtained from Valley Research, South Bend, Ind.; and the water soluble vitamin premix and oil soluble vitamin premix were supplied by Fortitech, Inc. of Schenectady, N.Y.

### EXAMPLE I

### Production of Beverage Containing an Enzyme Treated Soy Protein and Organic Brown Rice Symp

A 1000 kg batch of powder was manufactured using the process described below. In the first step, an appropriate amount of warm water (less than 120-130° F.) was added to a blend tank and the soymilk powder followed by the enzyme. The tricalcium phosphate was then added. Mixing occurred until the soymilk powder was completely wetted and dispersed. Following 120 minutes of mixing, the blend was heated to 150° F. The brown rice syrup was then added to the tank and agitation continued for 35 minutes with heating to maintain 150° F. In a separate kettle the HO sunflower oil and coconut oils were heated to 120-130° F. The lecithin was then added and dispersed, followed by the oil soluble vitamin premix. The oil blend was then added to the protein/carbohydrate slurry and this mixture was then heated to 150° F. The pH was checked and adjusted to 6.65-6.85 with Ca(OH)₂. KOH and NaOH can also be used. Mixing continued for an additional 25 minutes and then the blend was maintained at 150° F. The blend was about 40% by weight total solids. The slurry was then homogenized with 2000/500 psi followed by cooling to below 40° F.

The blend was standardized by adding the water soluble vitamin premix and vanilla flavor.

The blend was prepared for spray drying by first homogenizing at 1000 psi and then pasteurized with 180° F. for 16 seconds. The spray dryer used a 3500 psi nozzle pressure (a 72/1000 nozzle), with a 390° F. inlet temperature and an outlet temperature of 180° F. The resulting powder (2.5% water by weight) was fine, slightly tan in color and reconstituted readily. The powder was then placed in metal cans flushed with a mixture of carbon dioxide and nitrogen.

The beverage of the present invention can be made in a ready to consume form, in the form of a concentrate or in powder form. The nutritional beverage of the present invention, due to its use of organic soymilk powder and brown rice syrup, has been found to produce a refreshing, pleasant tasting beverage with excellent mouthfeel and smooth texture.

### Industrial Applicability

Some patients, infants and toddlers in need of nutritional supplementation simply do not like or should not be exposed to the chemical residues that are present in commercially available nutritional products. The product of this invention will also offer patients, infants and toddlers in need of calcium and/or iron supplementation a new supplement that will improve intake and thereby improve nutritional status. The organic product of this invention provides a high level of nutritional value in a beverage, which will be found useful in the medical community and readily accepted by parents of infants that know the value of organic products. Additionally, the product contains a non-dairy protein and is lactose free.

In accordance with the foregoing disclosure, it will be within the ability of one skilled in the relevant arts to make modifications to the present invention, such as through the substitution of equivalent materials and/or their amounts, without departing from the spirit of the invention as reflected in the appended claims.

We claim:

1. A ready-to-feed nutritional beverage comprising:
a) water;
b) from about 8 to about 12 gms of an organic brown rice syrup per 100 kcal of beverage; and
c) from about 0.1 to about 1.0 gms per 100 kcal of a source of calcium selected from tricalcium phosphate, calcium citrate, calcium carbonate, calcium lactate gluconate and mixtures thereof.

2. The beverage according to claim 1 additionally comprising a source of protein wherein said source of soy protein is organic soymilk powder subjected to an enzyme treatment.

3. The beverage according to claim 2 wherein said beverage additionally comprises:
a) at least one component selected from the group consisting of: pantothenic acid, biotin, vitamin B₁₂, folic acid, vitamin B₆, niacin, vitamin B₂, vitamin B₁ and a source of bioavailable iron; and
b) from about 6 to about 10 gms of organic soy protein per 100 kcal; and
c) from about 20-30 mg L-methionine per 100 kcal.

4. The beverage according to claim 3 wherein said beverage additionally comprises:
a) soy lecithin; and
b) at least one natural flavor.

5. The beverage according to claim 4 wherein said beverage additionally comprises:
a) at least one oil soluble vitamin; and
b) wherein said beverage has a pH of from about 6.5 to about 7.0.

6. The beverage according to claim 5 wherein said beverage is in the form of a concentrate or a powder.

7. The beverage according to claim 5 additionally containing at least one of eicosapentaenoic acid (EPA) and docosahexenoic acid (DHA).

8. The beverage according to claim 1 wherein said organic brown rice syrup has a D.E. of at least 25.

9. An organic nutritional beverage comprising:
a) soymilk powder;
d) alpha-galactosidase enzyme;
e) tricalcium phosphate;
c) brown rice syrup;
d) high oleic sunflower oil;
e) coconut oil;
g) soy lecithin;
h) flavor;
i) L-methionine;
j) oil soluble vitamins; and
k) water soluble vitamins.

10. The nutritional beverage according to claim 9 additionally containing at least one of eicosapentaenoic acid (EPA) and docosahexenoic acid (DHA).

11. A RTF organic nutritional beverage comprising in grams the following components per 100 kcal:
Bill of Materials

| Ingredient | Gms per 100 kcal |
|---|---|
| Soymilk Powder* | 6.38 |
| Tricalcium Phosphate | .310 |
| Validase AGS Enzyme | .016 |
| Brown Rice Syrup* | 12.679 |
| HO Sunflower Oil* | 1.89 |
| Coconut Oil* | .966 |
| L-Methionine | .025 |
| Soy Lecithin | .063 |
| Vanilla Flavor | .061 |
| Oil Soluble Vitamin Premix | 0.050 |
| Water Soluble Vitamin Premix | .170 |
| TOTAL | 22.63 |
